(19) United States
(12) Patent Application Publication
(10) Pub. No.: US 2015/0263430 A1
(43) Pub. Date: Sep. 17, 2015

(54) ANTENNA STRUCTURE

(71) Applicant: Quanta Computer Inc., Kuei Shan Hsiang (TW)

(72) Inventors: Chun-I Lin, Kuei Shan Hsiang (TW); Ming-Che Chan, Kuei Shan Hsiang (TW); Hui Lin, Kuei Shan Hsiang (TW)

(73) Assignee: Quanta Computer Inc., Kuei Shan Hsiang (TW)

(21) Appl. No.: 14/293,029

(22) Filed: Jun. 2, 2014

(30) Foreign Application Priority Data
Mar. 17, 2014 (TW) 103109865

(51) Int. Cl. H01Q 13/10; H01Q 5/30; H01Q 1/48

(52) U.S. Cl. CPC H01Q 13/106; H01Q 1/48; H01Q 5/30

(57) ABSTRACT

An antenna structure includes a ground plane and a grounding extension branch. The ground plane has a slot. The grounding extension branch is disposed in the slot, and is coupled to the ground plane. The ground plane and the slot are excited by a signal source to generate a low-frequency band. The grounding extension branch is excited by the signal source to generate a high-frequency band.

### CROSS REFERENCE TO RELATED APPLICATIONS

This Application claims priority of Taiwan Patent Application No. 103109865 filed on Mar. 17, 2014, the entirety of which is incorporated by reference herein.

### BACKGROUND OF THE INVENTION

1. Field of the Invention

The disclosure generally relates to an antenna structure, and more particularly, to an antenna structure for covering two frequency bands.

2. Description of the Related Art

With the progress of mobile communication technology, mobile devices, for example, portable computers, mobile phones, tablet computers, multimedia players, and other hybrid functional portable electronic devices, have become more common To satisfy the demand of users, mobile devices usually can perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

Antennas are indispensable to mobile devices with wireless communication functions. Since design space in mobile devices is usually limited, it becomes a critical challenge for antenna engineers to minimize the size of antenna elements without affecting the communication quality thereof.

### BRIEF SUMMARY OF THE INVENTION

In a preferred embodiment, the disclosure is directed to an antenna structure including a ground plane and a grounding extension branch. The ground plane has a slot. The grounding extension branch is disposed in the slot, and is coupled to the ground plane. The ground plane and the slot are excited by a signal source to generate a low-frequency band. The grounding extension branch is excited by the signal source to generate a high-frequency band.

In another preferred embodiment, the disclosure is directed to an antenna structure including a ground plane, a dielectric substrate, and a feeding element. The ground plane has a slot. The feeding element includes a feeding extension branch. The ground plane is disposed on a first surface of the dielectric substrate, and the feeding element is disposed on a second surface of the dielectric substrate. The first surface is opposite to the second surface. The feeding element further extends across the slot of the ground plane. The ground plane and the slot are excited by a signal source to generate a low-frequency band. The feeding extension branch is excited by the signal source to generate a high-frequency band.

### BRIEF DESCRIPTION OF DRAWINGS

The invention can be more fully understood by reading the subsequent detailed description and examples with references made to the accompanying drawings, wherein:

FIG. 1 is a diagram of an antenna structure according to an embodiment of the invention;

FIG. 2 is a diagram of an antenna structure according to an embodiment of the invention;

FIG. 3 is a diagram of a VSWR (Voltage Standing Wave Ratio) of an antenna structure according to an embodiment of the invention.

FIG. 4 is a diagram of an antenna structure according to an embodiment of the invention;

FIG. 5 is a diagram of an antenna structure according to an embodiment of the invention;

FIG. 6 is a diagram of an antenna structure according to an embodiment of the invention; and

FIG. 7 is a diagram of an antenna structure according to an embodiment of the invention.

### DETAILED DESCRIPTION OF THE INVENTION

In order to illustrate the purposes, features and advantages of the invention, the embodiments and figures of the invention are shown in detail as follows.

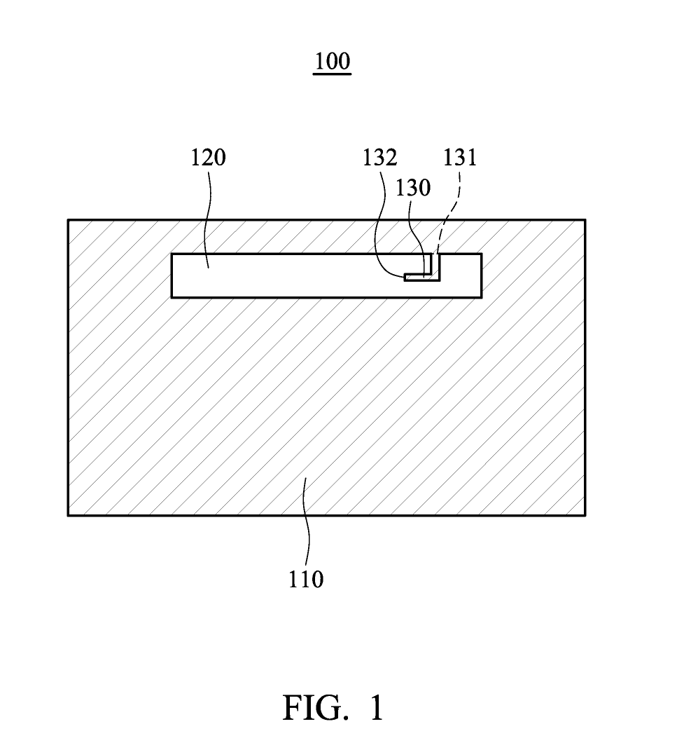

FIG. 1 is a diagram of an antenna structure 100 according to an embodiment of the invention. The antenna structure 100 may be designed in a mobile device, such as a smartphone, a tablet computer, or a notebook computer. As shown in FIG. 1, the antenna structure 100 at least includes a ground plane 110 and a grounding extension branch 130. The ground plane 110 and the grounding extension branch 130 may be made of metal, such as copper, silver, iron, aluminum, or their alloys. In some embodiments, the antenna structure 100 is further coupled to a wireless communication module, a transceiver, and/or a signal processing module of the mobile device (not shown).

The ground plane 110 has a slot 120. In the embodiment of FIG. 1, the slot 120 of the ground plane 110 is substantially a rectangular closed slot. In other embodiments, the slot 120 of the ground plane 110 has a different shape, such as a circular shape, an elliptical shape, an L-shape, or a J-shape. The grounding extension branch 130 is disposed in the slot 120 of the ground plane 110, and is coupled to the ground plane 110. More particularly, a first end 131 of the grounding extension branch 130 is coupled to an edge of the slot 120 of the ground plane 110, and a second end 132 of the grounding extension branch 130 is open. In the embodiment of FIG. 1, the grounding extension branch 130 substantially has an inverted L-shape. That is, a portion of the grounding extension branch 130 is substantially perpendicular to the edge of the slot 120, and another portion of the grounding extension branch 130 is substantially parallel to the edge of the slot 120. In other embodiments, the grounding extension branch 130 has a different shape, such as a straight-line shape, a J-shape, or a U-shape. In a preferred embodiment, when the antenna structure 100 is fed from a signal source (not shown), the ground plane 110 and the slot 120 form a slot antenna element which is excited to generate a low-frequency band, and the grounding extension branch 130 forms a monopole antenna element which is excited to generate a high-frequency band. The signal source may be an RF (Radio Frequency) module of the mobile device. By combining the low-frequency band with the high-frequency band, the antenna structure 100 can cover at least two wide frequency bands. It is noted that the antenna structure 100 may have a variety of configurations and feeding arrangements, and its detailed designs will be disclosed in the following embodiments.

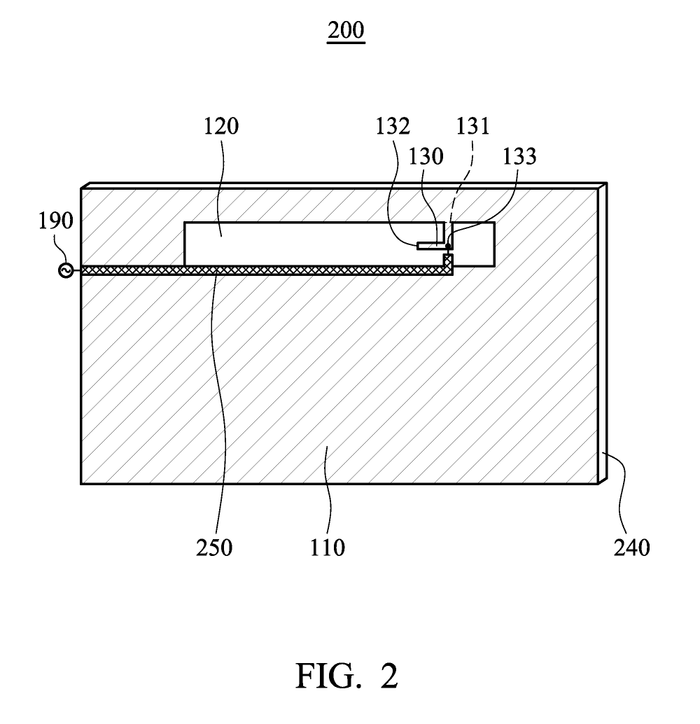

FIG. 2 is a diagram of an antenna structure 200 according to an embodiment of the invention. FIG. 2 is similar to FIG. 1. In the embodiment of FIG. 2, the antenna structure 200 further includes a dielectric substrate 240, such as an FR4 (Flame Retardant 4) substrate, a system circuit board, or an FPCB (Flexible Printed Circuit Board). The ground plane 110 and the slot 120 of the antenna structure 200 are formed on a surface of the dielectric substrate 240. In addition, a signal source 190 is coupled through a coaxial cable 250 to a feeding point 133 on the grounding extension branch 130 of the antenna structure 200, and therefore the antenna structure 200 (including the slot antenna element and the monopole antenna element) is excited by using a direct-feeding mechanism. More particularly, a positive electrode of the signal source 190 is coupled through a central conductor of the coaxial cable 250 to the feeding point 133, and a negative electrode of the signal source 190 is coupled through a housing conductor of the coaxial cable 250 to the ground plane 110. It is understood that the feeding mechanism of the coaxial cable 250 is just exemplary, and the invention is not limited thereto. Other features of the antenna structure 200 of FIG. 2 are similar to those of the antenna structure 100 of FIG. 1. Therefore, the two embodiments can achieve similar levels of performance.

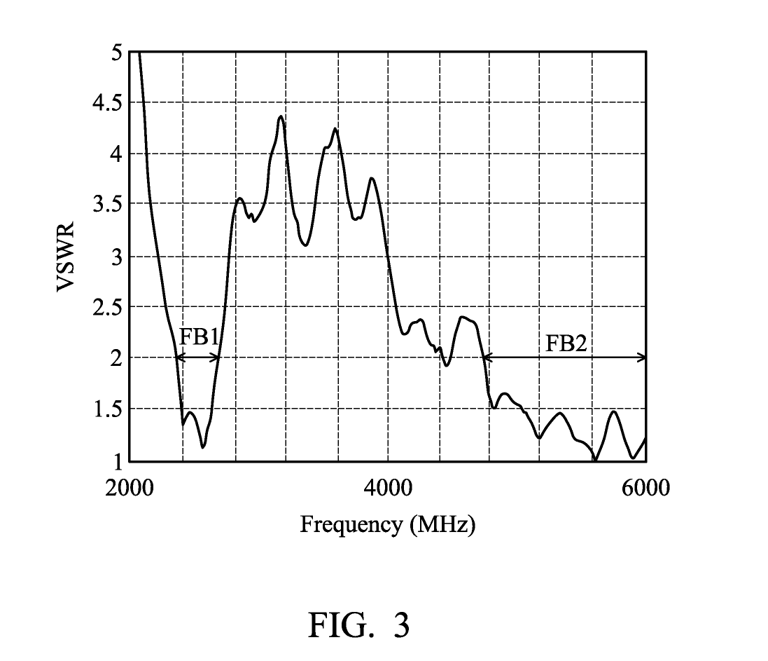

FIG. 3 is a diagram of a VSWR (Voltage Standing Wave Ratio) of the antenna structure 200 according to an embodiment of the invention. The horizontal axis represents operation frequency (MHz), and the vertical axis represents the VSWR. When the antenna structure 200 is fed from the signal source 190, the ground plane 110 and the slot 120 are excited to generate a low-frequency band FB1, and the grounding extension branch 130 is excited to generate a high-frequency band FB2. In a preferred embodiment, the low-frequency band FB1 is from about 2400 MHz to about 2480 MHz, and the high-frequency band FB2 is from about 5150 MHz to about 5850 MHz. As a result, the antenna structure 200 of the invention can at least support WLAN (Wireless Local Area Network) 2.4 GHz and 5 GHz dual-band operations. According to some measurements, the antenna efficiency of the antenna structure 200 operating in the low-frequency band FB1 is higher than 37%, and the antenna efficiency of the antenna structure 200 operating in the high-frequency band FB2 is higher than 45%. It can meet practical applications of mobile communication devices.

With respect to element sizes, the slot 120 of the ground plane 110 (forming the slot antenna element) may have a length which is substantially equal to 0.5 wavelength (0.52) of the low-frequency band FB1, and the grounding extension branch 130 (forming the monopole antenna element) may have a length which is substantially equal to 0.25 wavelength (0.25 λ) of the high-frequency band FB2. In some embodiments, the element sizes of the antenna structure 200 are as follows. The ground plane 110 has a length of about 60 mm, and a width of about 11 mm. The slot 120 of the ground plane 110 has a length of about 44 mm, and a width of about 6 mm. The grounding extension branch 130 has a length of about 10 mm, and a width of about 1.3 mm.

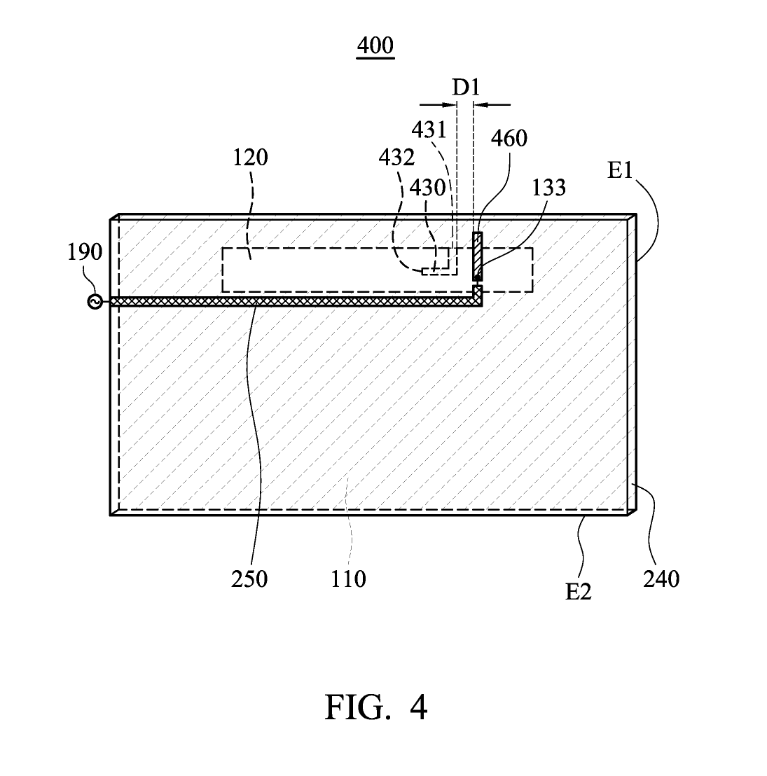

FIG. 4 is a diagram of an antenna structure 400 according to an embodiment of the invention. FIG. 4 is similar to FIG. 1. In the embodiment of FIG. 4, the antenna structure 400 further includes a dielectric substrate 240 and a feeding element 460. The feeding element 460 substantially has a straight-line shape. The feeding element 460 may be made of metal, such as copper, silver, iron, aluminum, or their alloys. In the antenna structure 400, the ground plane 110, the slot 120, and a grounding extension branch 430 are formed on a first surface E1 of the dielectric substrate 240, and the feeding element 460 is formed on a second surface E2 of the dielectric substrate 240. The first surface E1 is opposite to the second surface E2. The grounding extension branch 430 substantially has an inverted L-shape. The feeding element 460 further extends across the slot 120 of the ground plane 110. The signal source 190 is coupled through the coaxial cable 250 to the feeding element 460, and therefore the antenna structure 400 (including the slot antenna element and the monopole antenna element) is excited by using a coupling-feeding mechanism. More particularly, the positive electrode of the signal source 190 is coupled through the central conductor of the coaxial cable 250 to one end of the feeding element 460, and the negative electrode of the signal source 190 is coupled through the housing conductor of the coaxial cable 250 to the ground plane 110. A via element and a grounding pad (not shown) may be further formed in the dielectric substrate 240, and may couple the housing conductor of the coaxial cable 250 to the ground plane 110. In some embodiments, the feeding element 460 has a vertical projection on the first surface E1 of the dielectric substrate 240, and the spacing D1 between the vertical projection and the grounding extension branch 430 should be shorter than 5 mm. The above design can keep the grounding extension branch 430 being well excited. Other features of the antenna structure 400 of FIG. 4 are similar to those of the antenna structure 100 of FIG. 1. Therefore, the two embodiments can achieve similar levels of performance.

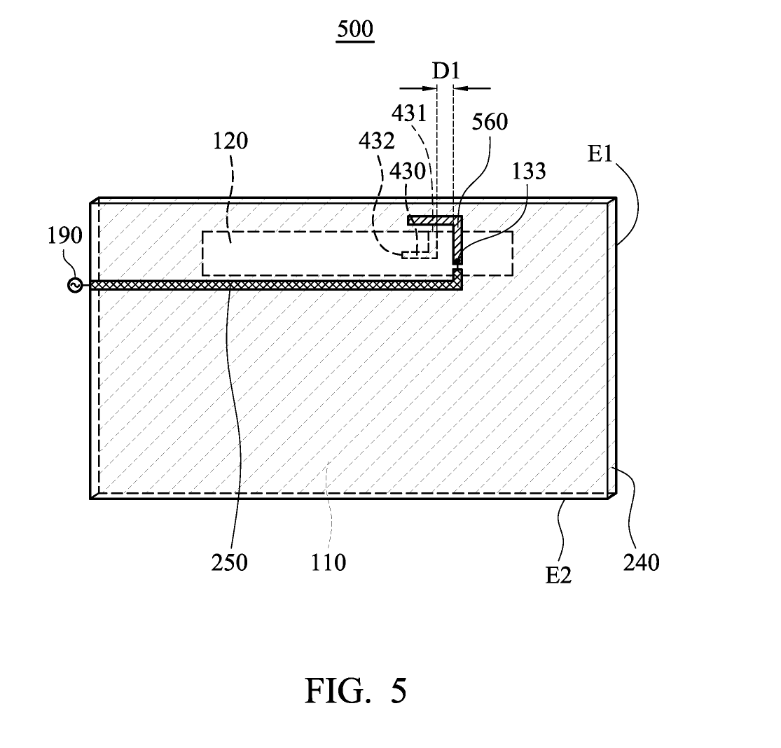

FIG. 5 is a diagram of an antenna structure 500 according to an embodiment of the invention. FIG. 5 is similar to FIG. 4. In the embodiment of FIG. 5, a feeding element 560 of the antenna structure 500 substantially has an inverted L-shape. One end of the feeding element 560 extends toward the grounding extension branch 430. The different shape of the feeding element 560 can adjust the impedance matching of the antenna structure 500 and increase the antenna efficiency of the antenna structure 500. Other features of the antenna structure 500 of FIG. 5 are similar to those of the antenna structure 400 of FIG. 4. Therefore, the two embodiments can achieve similar levels of performance.

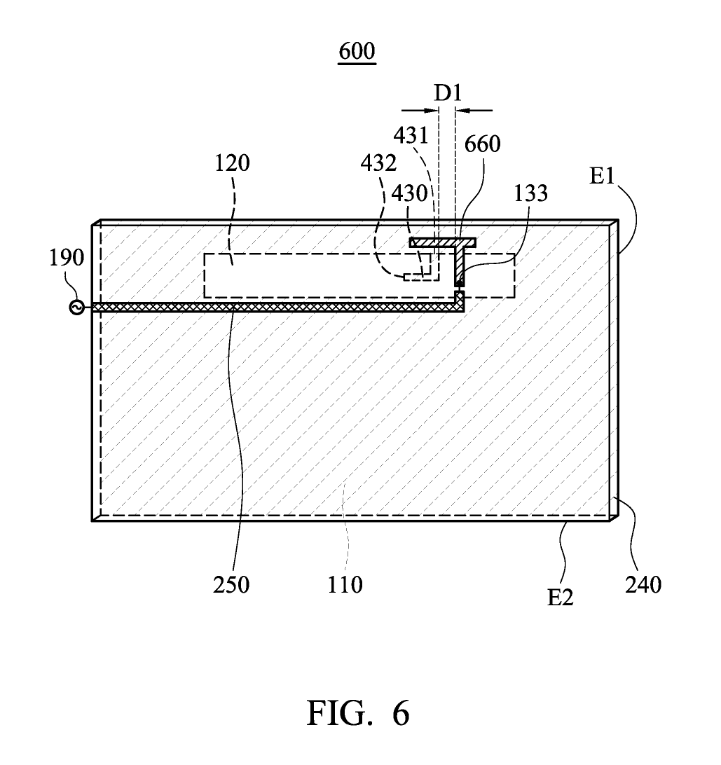

FIG. 6 is a diagram of an antenna structure 600 according to an embodiment of the invention. FIG. 6 is similar to FIG. 4. In the embodiment of FIG. 6, a feeding element 660 of the antenna structure 600 substantially has a T-shape. The feeding element 660 includes a long branch and a short branch. The long branch extends toward the grounding extension branch 430, but the short branch extends away from the grounding extension branch 430. The different shape of the feeding element 660 can adjust the impedance matching of the antenna structure 600 and increase the antenna efficiency of the antenna structure 600. Other features of the antenna structure 600 of FIG. 6 are similar to those of the antenna structure 400 of FIG. 4. Therefore, the two embodiments can achieve similar levels of performance.

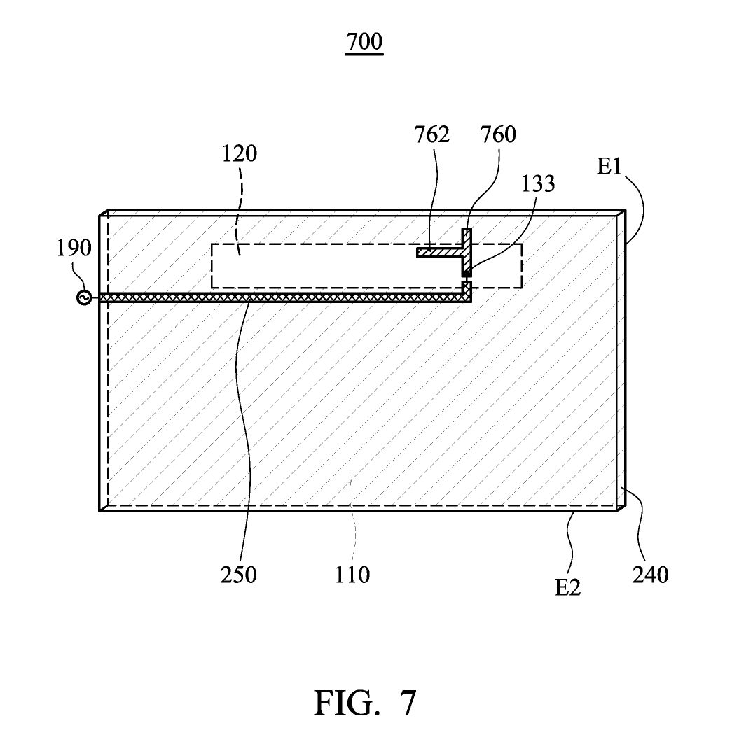

FIG. 7 is a diagram of an antenna structure 700 according to an embodiment of the invention. FIG. 7 is similar to FIG. 4. In the embodiment of FIG. 7, a feeding element 760 of the antenna structure 700 further includes a feeding extension branch 762, but no grounding extension branch is disposed in the slot 120 of the ground plane 110 of the antenna structure 700. The feeding element 760 substantially has an inverted T-shape. The feeding extension branch 762 is substantially perpendicular to the other portions of the feeding element 760. When the antenna structure 700 is fed from the signal source 190, the ground plane 110 and the slot 120 form a slot antenna element which is excited to generate a low-frequency band, and the feeding extension branch 762 forms a monopole antenna element which is excited to generate a high-frequency band. In other words, the feeding extension branch 762 provides a high-frequency resonant path, and it has a similar function to the omitted grounding extension branch. Other features of the antenna structure 700 of FIG. 7 are similar to those of the antenna structure 400 of FIG. 4. Therefore, the two embodiments can achieve similar levels of performance.

In conclusion, the antenna structure of the invention includes a slot antenna element for generating magnetic currents, and a monopole antenna element for generating electric currents. In some embodiments, since the slot antenna element may be formed on a metal back cover of a mobile device, the metal back cover can form a portion of an antenna structure and accordingly does not negatively affect the radiation performance of the antenna structure (e.g., the metal back cover does not shield electromagnetic waves from the antenna structure). On the other hand, the monopole antenna element is disposed inside the slot antenna element, and it further reduces the size of the whole antenna structure. In comparison to the prior art, the invention at least has the advantages of covering multiple frequency bands, increasing the antenna bandwidth, minimizing the antenna size, and maintaining the antenna efficiency, and therefore the invention is suitable for application in a variety of small-size mobile communication devices.

Note that the above element sizes, element shapes, and frequency ranges are not limitations of the invention. An antenna engineer can adjust these settings or values according to different requirements. It is understood that the antenna structure of the invention are not limited to the configurations of FIGS. 1-7. The invention may merely include any one or more features of any one or more embodiments of FIGS. 1-7. In other words, not all of the features shown in the figures should be implemented in the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An antenna structure, comprising:
a ground plane, having a slot; and
a grounding extension branch, disposed in the slot, and coupled to the ground plane;
wherein the ground plane and the slot are excited by a signal source to generate a low-frequency band, and the grounding extension branch is excited by the signal source to generate a high-frequency band.

2. The antenna structure as claimed in claim 1, wherein the slot of the ground plane is substantially a rectangular closed slot.

3. The antenna structure as claimed in claim 1, wherein a first end of the grounding extension branch is coupled to an edge of the slot of the ground plane, and a second end of the grounding extension branch is open.

4. The antenna structure as claimed in claim 1, wherein the grounding extension branch substantially has an inverted L-shape.

5. The antenna structure as claimed in claim 1, wherein the signal source is coupled to a feeding point on the ground extension branch.

6. The antenna structure as claimed in claim 1, further comprising:
a dielectric substrate; and
a feeding element, coupled to the signal source;
wherein the ground plane and the grounding extension branch are disposed on a first surface of the dielectric substrate, the feeding element is disposed on a second surface of the dielectric substrate, the first surface is opposite to the second surface, and the feeding element

7. The antenna structure as claimed in claim 6, wherein the feeding element substantially has an inverted L-shape.

8. The antenna structure as claimed in claim 1, wherein the low-frequency band is from about 2400 MHz to about 2480 MHz, and the high-frequency band is from about 5150 MHz to about 5850 MHz.

9. An antenna structure, comprising:
a ground plane, having a slot;
a dielectric substrate; and
a feeding element, comprising a feeding extension branch;
wherein the ground plane is disposed on a first surface of the dielectric substrate, the feeding element is disposed on a second surface of the dielectric substrate, the first surface is opposite to the second surface, and the feeding element further extends across the slot of the ground plane; and
wherein the ground plane and the slot are excited by a signal source to generate a low-frequency band, and the feeding extension branch is excited by the signal source to generate a high-frequency band.

10. The antenna structure as claimed in claim 9, wherein the feeding element
